(19) United States
(12) Patent Application Publication
(10) Pub. No.: US 2019/0325525 A1
(43) Pub. Date: Oct. 24, 2019

(54) INSURANCE PRICE DETERMINATION OF AUTONOMOUS VEHICLE BASED ON PREDICTED ACCIDENT THREAT FROM SURROUNDING VEHICLES

(71) Applicant: International Business Machines Corporation, Armonk, NY (US)

(72) Inventors: ERIC V. KLINE, ROCHESTER, MN (US); SARBAJIT K. RAKSHIT, KOLKATA (IN)

(21) Appl. No.: 15/961,159

(22) Filed: Apr. 24, 2018

(51) Int. Cl. G06Q 40/08; G01C 21/34

(52) U.S. Cl. CPC G06Q 40/08; G01C 21/3461

(57) ABSTRACT

A processor implemented method is provided. The processor implemented method can include determining, by a processor, a preferred path from one or more paths for an autonomous vehicle based on a start point and an end point. The processor implemented method can include dividing, by the processor, the preferred path into one or more segments. The processor implemented method can include determining, by the processor, one or more risk indexes for each of the one or more segments. The processor implemented method can include determining, by the processor, an insurance cost for the preferred path based on the one or more risk indexes.

### BACKGROUND

The disclosure relates generally to autonomous vehicles, and more specifically, to methods and systems for insurance price determination of autonomous vehicle based on predicted accident threat from surrounding vehicles.

In general, autonomous vehicles operate alongside manual driven vehicles. A ratio between the autonomous vehicles and the manually driven vehicles can vary from location to location. While this ratio should help predict accident rates for the autonomous vehicles, at present, there is no way to determine correctly determine this ratio and/or insurance metrics in view of this ratio.

### SUMMARY

According to one or more embodiments, a processor implemented method is provided. The processor implemented method can include determining, by a processor, a preferred path from one or more paths for an autonomous vehicle based on a start point and an end point. The processor implemented method can include dividing, by the processor, the preferred path into one or more segments. The processor implemented method can include determining, by the processor, one or more risk indexes for each of the one or more segments. The processor implemented method can include determining, by the processor, an insurance cost for the preferred path based on the one or more risk indexes.

According to one or more embodiments, a computer program product is provided. The computer program product includes a computer readable storage medium having program instructions embodied therewith. The program instructions are executable by a processor to cause a determining of a preferred path from one or more paths for an autonomous vehicle based on a start point and an end point. The program instructions are executable by a processor to cause a dividing of the preferred path into one or more segments. The program instructions are executable by a processor to cause a determining of one or more risk indexes for each of the one or more segments. The program instructions are executable by a processor to cause a determining of an insurance cost for the preferred path based on the one or more risk indexes.

According to one or more embodiments, a system is provided. The system includes a processor and a memory storing program instructions thereon. The program instructions are executable by a processor to cause a determining of a preferred path from one or more paths for an autonomous vehicle based on a start point and an end point. The program instructions are executable by a processor to cause a dividing of the preferred path into one or more segments. The program instructions are executable by a processor to cause a determining of one or more risk indexes for each of the one or more segments. The program instructions are executable by a processor to cause a determining of an insurance cost for the preferred path based on the one or more risk indexes.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter is particularly pointed out and distinctly claimed in the claims at the conclusion of the specification. The forgoing and other features, and advantages of the embodiments herein are apparent from the following detailed description taken in conjunction with the accompanying drawings in which:

FIG. 1 depicts a cloud computing environment in accordance with one or more embodiments;

FIG. 2 depicts abstraction model layers in accordance with one or more embodiments;

FIG. 3 depicts a communication schematic of a system in accordance with one or more embodiments;

FIG. 4 depicts a process flow of a system in accordance with one or more embodiments; and

FIG. 5 depicts a process flow of a system in accordance with one or more embodiments.

### DETAILED DESCRIPTION

In view of the above, embodiments disclosed herein may include systems, methods, and/or computer program products (herein collectively referred to as a system) that perform an insurance price determination of autonomous vehicle based on predicted accident threat from surrounding vehicles.

In accordance with one or more embodiments, the system determines insurance prices based on the distribution of manual vehicles around autonomous vehicles, while accounting for an exposure time of the autonomous vehicles to the manually driven vehicles (i.e., the predicted accident threat from surrounding vehicles). For example, the system utilizes travel maps for the autonomous vehicles to identify an anticipated density (e.g., distribution of manual vehicles) and the exposure time of the manual vehicles to the autonomous vehicles per map segment (e.g., neighborhood, main road, highway, etc.) of the travel maps. The system determines accidents rates per map segment based on the anticipated density and the exposure time. The system determines an accident risk and an insurance price relevant to that accident risk based on the accidents rates per map segment for each travel map.

The technical effects and benefits of the system include creating risk knowledge data from vehicle and system sourced information that otherwise is not available or in existence. The technical effects and benefits to the system also include real-time and accurate risk determinations in accordance with use rather than an average claim for a category, as these determination are otherwise not possible without the risk knowledge data for a particular route (e.g., travel map) of an autonomous vehicle. Thus, embodiments described herein are necessarily rooted in the system and processors thereof to perform proactive operations to overcome problems specifically arising in the realm of determining insurance metrics in view of a ratio between the autonomous vehicles and the manually driven vehicles.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

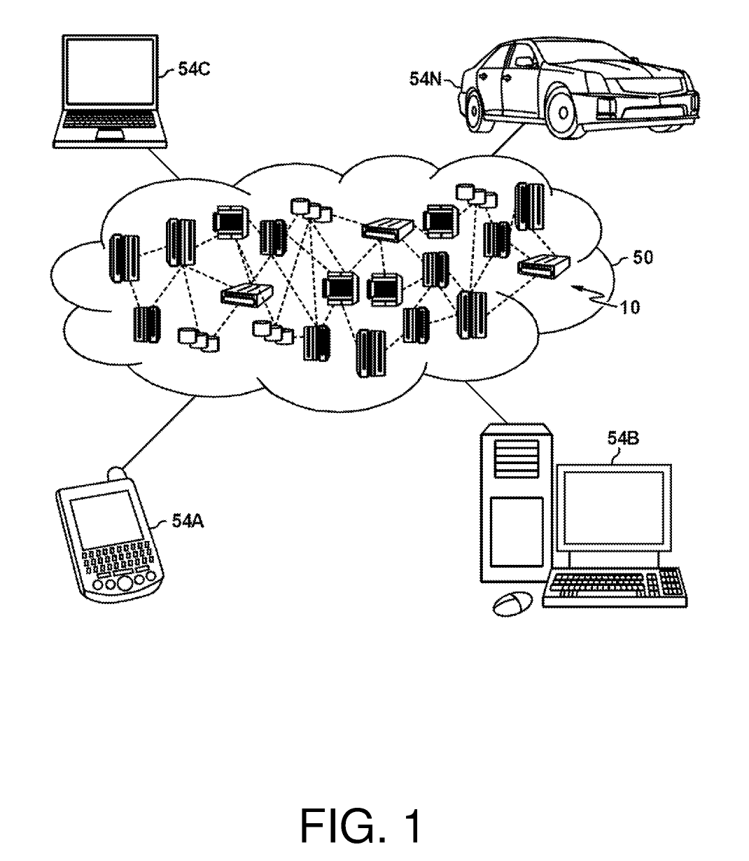

Referring now to FIG. 1, illustrative cloud computing environment 50 is depicted. As shown,

cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system

54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

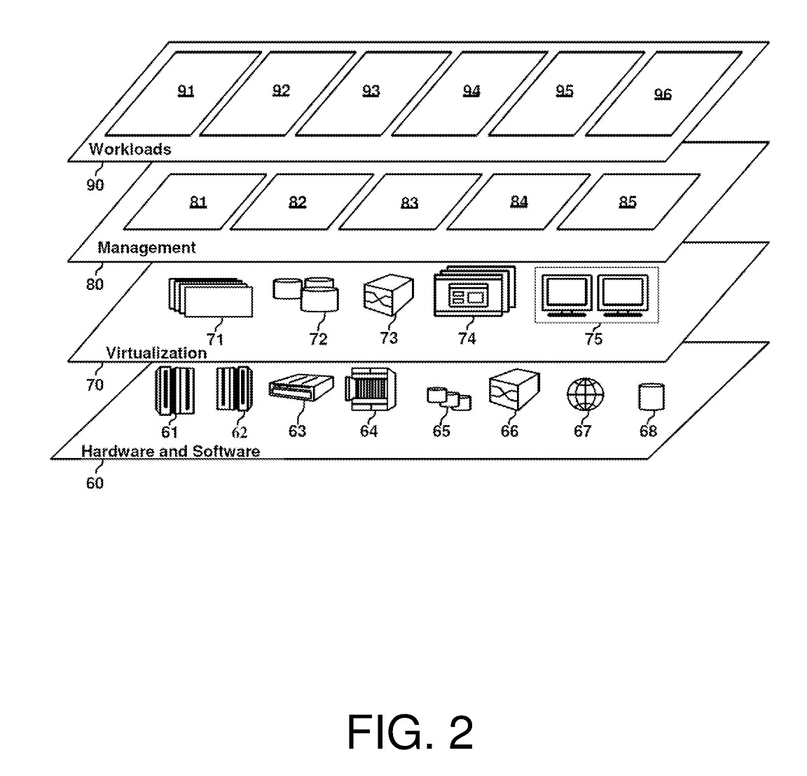

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and insurance price processing 96.

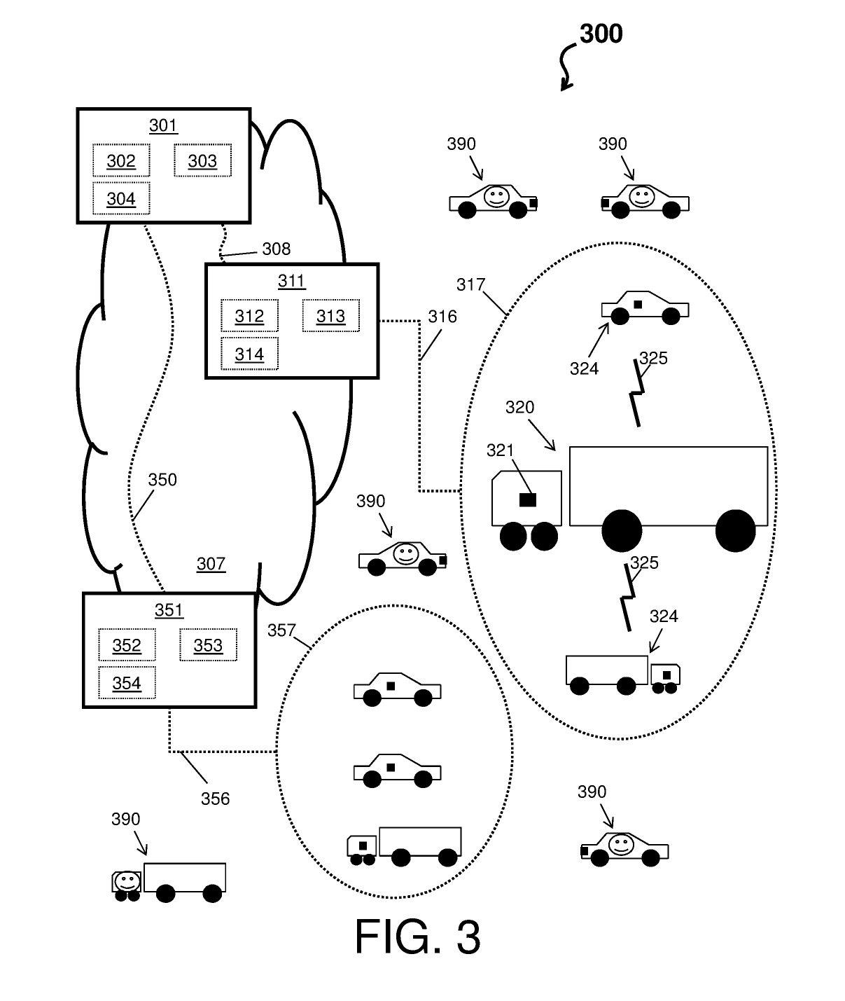

Turning now to FIG. 3, a system 300 is generally shown in accordance with one or more embodiments. As shown in FIG. 1, the system 300 comprises an insurance server 301 including a processor 302, a memory 303, and a transceiver 304. The insurance server 301 communicates through a network 307 via a connection 308 with a vehicle fleet server 311 of the system 300. The vehicle fleet server 311 comprises a processor 312, a memory 313, and a transceiver 314. The vehicle fleet server 311 communicates via one or more connections (represented as connection 316) with a vehicle fleet 317. The vehicle fleet 317 comprises an autonomous vehicle 320 including a computing system 321 and one or more autonomous vehicles 324 respectively including computing systems (not labeled for brevity). The autonomous vehicles 320, 324 can communicate amongst themselves as represented by connections 325. The insurance server 301 also communicates through the network 307 via a connection 350 with a vehicle fleet server 351 of the system 300. The vehicle fleet server 351 comprises a processor 352, a memory 353, and a transceiver 354. The vehicle fleet server 351 communicates via one or more connections (represented as connection 356) with a vehicle fleet 357 (autonomous vehicles therein are not labeled for brevity). Note that one or more manual vehicles 390 operate amongst the vehicle fleets 317, 357.

The system 300 can be an electronic, computer framework comprising and/or employing any number and combination of computing device and networks utilizing various communication technologies, as described herein. The system 300 can be easily scalable, extensible, and modular, with the ability to change to different services or reconfigure some features independently of others. In accordance with one or more embodiments, the system 300 can be implemented as a distributed system and/or cloud system as described herein.

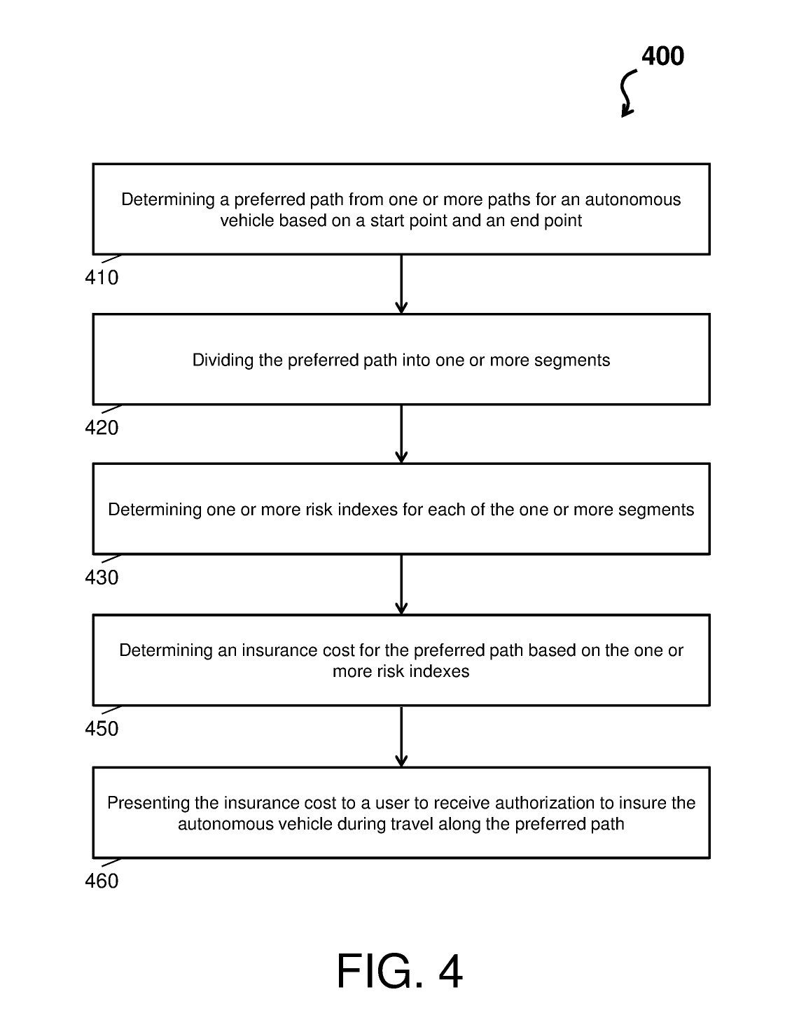

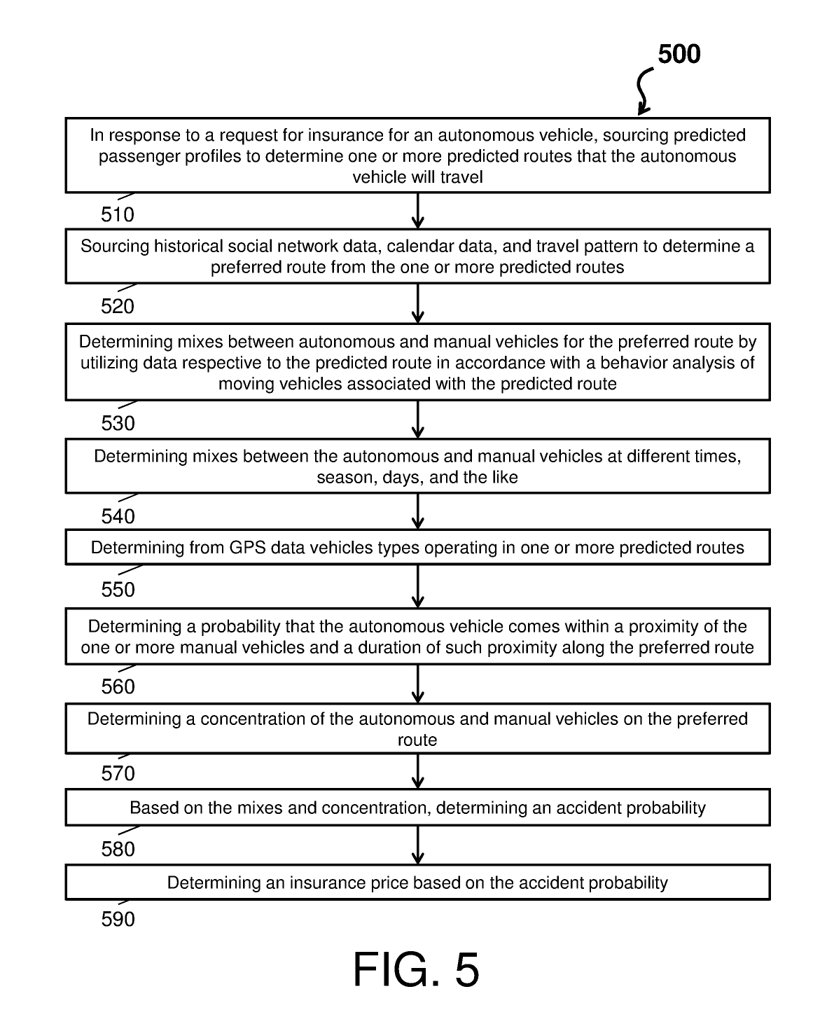

The insurance server 301, the vehicle fleet server 311, and the vehicle fleet server 351 (and the computing system 321) can be any computing device comprising one or more central processing units (the processors 302, 312, and 352 respectively, collectively referred to as processors). Processors, also referred to as processing circuits, are coupled via a system bus to system memory and various other components. Software for execution on the insurance server 301, the vehicle fleet server 311, and/or the vehicle fleet server 351 may be stored in the memories 303, 313, and 353 respectively, collectively referred to as system memory. The system memory can include a read only memory (ROM) and a random access memory (RAM). The ROM is coupled to the system bus and may include a basic input/output system (BIOS), which controls certain basic functions of the computing device. The RAM is read-write memory coupled to the system bus for use by the processors. The system memory is an example of a tangible storage medium readable by the processors, where the software is stored as instructions for execution by the processors to cause the system 300 to operate, such as is described herein with reference to FIGS. 4-5. Examples of computer program product and the execution of such instruction is discussed herein in more detail. The transceivers 304, 314, and 354 are representative of one or more input/output adapters (e.g., small computer system interface adapter that communicates with a hard disk and/or any other similar component), communications adapters (interconnecting the system bus with the network 307 and enabling the communications with other systems/devices), and display adapters (e.g., graphics controller coupled to a display) coupled to the system bus.

The autonomous vehicles 320, 324 and/or the one or more manual vehicles 390 can be anything used for transporting people, devices, or goods, on land, sea, or air, such as a car, truck, cart, forklift, plane, boat, tractor, drone, submarine, etc. The autonomous vehicles 320, 324 are more specifically an unmanned vehicle capable of sensing its environment and navigating without human input. The autonomous vehicles 320, 324 can use a variety of techniques to detect their environment and surroundings, such as radar, laser light, global positioning systems (GPS), odometry, computer vision, etc. The autonomous vehicles 320, 324 can navigate from one place to another base on monitoring, instructions, and control by the vehicle fleet servers 317, 357 and/or through self-determination of routes.

In an example operation, the system 300 determines insurance prices based on the distribution of manual vehicles 390 around autonomous vehicles 320, 324, while accounting for an exposure time of the autonomous vehicles 320, 324 to the manual driven vehicles or manual vehicles 390 (i.e., the predicted accident threat from surrounding vehicles). In this way, the insurance server 301 is improved and enhanced because it utilizes the logic that accident rates are more likely to be higher in surroundings where a concentration of the manual vehicles 390 is more than a concentration of the autonomous vehicles 320, 324. Further, accident rates are more likely to be lower in surroundings where the concentration of the manual vehicles 390 is less than the concentration of the autonomous vehicles 320, 324. Since accidents rates directly relate to the concentration of and an exposure to the manual vehicles 390 by the autonomous vehicles 320, 324, the insurance metrics of the autonomous vehicles 320, 324 are be calculated based on how much time the autonomous vehicles 320, 324 are exposed to the manual vehicles 390, and the noted distribution ratio.

In accordance with one or more embodiments, the insurance server 301 calculates an insurance price of the autonomous vehicle 320 calculated based on the predicted movement of the autonomous vehicle 320 in manual driven vehicle surrounding. The insurance server 301 utilizes travel maps for the autonomous vehicle 320 to identify an anticipated density (e.g., distribution of manual vehicles) and the exposure time of the manual vehicles 390 to the autonomous vehicle 320 per map segment (e.g., neighborhood, main road, highway, etc.) of the travel maps. The insurance server 301 determines accidents rates per map segment based on the anticipated density and the exposure time. The insurance server 301 determines an accident risk and an insurance price relevant to that accident risk based on the accidents rates per map segment for each travel map.

In view of the above system 300, example operations with respect to FIGS. 4 and 5 are now described.

Turning now to FIG. 4, a process flow 400 is generally shown in accordance with one or more embodiments. The process flow 400 begins at block 410 where the processor 302 of the insurance server 301 determines a preferred path from one or more paths for the autonomous vehicle 320 based on a start point and an end point. In operation, the vehicle fleet server 311 determines a destination (e.g., end point) for the autonomous vehicle 320. Further, the vehicle fleet server 311 identifies a current location (e.g., a start point) of the autonomous vehicle 320. Multiple paths or routes are determined for the autonomous vehicle 320 to travel to the destination from the current location. To determine a preferred path from one or more paths, the vehicle fleet server 311 can select the fastest path, the path with the most highways, and/or the path with the least vehicle volume. The vehicle fleet server 311 can communicate the preferred path to the insurance server 301. In accordance with another embodiment, the computing system 321 of the autonomous vehicle 320, the insurance server 301, and/or a mobile device of a user can determine the preferred path. In accordance with another embodiment, a mobile device of a user ordering a car or transportation service can provide an end point for passenger pick-up and/or an end point for passenger drop-off. Further, while a single end point is described with respect to block 410 for ease of explanation, a single end point is representative of one or more endpoints. Each of the one or more endpoints can be a different destination for delivering/dropping-off/picking-up goods or people.

At block 420, the processor divides the preferred path into one or more segments. The one or more segments can be defined based on road categories (e.g., highways, main roads, neighborhood streets, etc.) and/or road zones (e.g., construction zone, school zone, stadium zone, airport zone). The preferred path can be a single segment, such as a path that is exclusively main road travel. In accordance with another embodiment, the vehicle fleet server 311, the computing system 321 of the autonomous vehicle 320, the insurance server 301, and/or a mobile device of a user can divide the preferred path of the autonomous vehicle 320. For instance, to divide the preferred path, the vehicle fleet server 311 can identify which portions of the preferred path travel are associated with different road categories and/or zones.

At block 430, the processor determines one or more risk indexes for each of the one or more segments. The one or more risk indexes are alphanumerical values assigned to each road segment based on one or more factors, and a total risk index can be derived from the one or more risk indexes. These factors comprise, but are not limited to, ratios between autonomous and manual vehicles, the proximity between the autonomous and manual vehicles, the concentration of the autonomous vehicles, the concentration of the autonomous vehicles, GPS data, passenger profiles, social network data, calendar data, and travel pattern. In accordance with an embodiment, each risk index is a value on a range from 0 to 10, with 0 representing no risk and 10 representing a maximum risk. A total risk index can, in turn, be determined by dividing the sum of risk indexes by a ten times the number of segments. In accordance with another embodiment, the vehicle fleet server 311, the computing system 321 of the autonomous vehicle 320, the insurance server 301, and/or a mobile device of a user can determine the one or more risk indexes and the total risk index.

At block 450, the processor determines an insurance cost for the preferred path based on the one or more risk indexes. In accordance with another embodiment, the vehicle fleet server 311, the computing system 321 of the autonomous vehicle 320, the insurance server 301, and/or a mobile device of a user can determine an insurance cost for the preferred path based on the one or more risk indexes. For example, the insurance server 301 receives the one or more risk indexes and the total risk index and utilizes these indexes with respect to one or more actuarial tables or spreadsheets (e.g., identifying a probability that the autonomous vehicle 320 with be involved in an accident while on the preferred route) to determine the insurance cost.

At block 460, the processor presents the insurance cost to a user to receive authorization to insure the autonomous vehicle during travel along the preferred path. For instance, a manager of the vehicle fleet 317 (e.g., a user) can receive a notification indicating the insurance cost for the autonomous vehicle 320 to travel on the preferred route. The manager of the vehicle fleet 317 can then provide a user input to the system 300, through the vehicle fleet server 311 or computing/mobile device connected to the system 300, indicating consent to the insurance cost. This consent is an authorization to insure the autonomous vehicle for the preferred route only.

Turning now to FIG. 5, a process flow 500 is generally shown in accordance with one or more embodiments. The process flow 500 begins at block 510 where the processor 302 of the insurance server 301, in response to a request for insurance for an autonomous vehicle, sources predicted passenger profiles to determine one or more predicted routes that the autonomous vehicle will travel. Once any autonomous vehicle is to be insured, the system 300 can gather driver's and other predicted passengers profile to find possible predicted routes where the autonomous vehicle 320 will travel. Further, software within the system can be predicting the possible passengers and varied needs of the passengers, while possible paths/routes where one or more manual vehicles 390 operate. The system 300 can also predict various target destinations, where the autonomous vehicle 320 needs to be parked at the conclusion of a path/route and the one or more manual vehicles 39 area also parked.

At block 520, the processor sources historical social network data, calendar data, and travel pattern to determine a preferred route from the one or more predicted routes. At block 530, the processor determines mixes between autonomous and manual vehicles for the preferred route by utilizing data respective to the predicted route in accordance with a behavior analysis of moving vehicles associated with the predicted route. The system 300 can be analyzing closes circuit television footage data from the predicted route identified for any autonomous vehicles, and accordingly based on behavior analysis of the moving vehicles in associated roads. For example, software of the system 300 can identify ratios between autonomous vehicles and manual vehicles.

At block 540, the processor determines mixes between the autonomous and manual vehicles at different times, season, days, and the like. For example, software of the system 300 can identify ratios between autonomous vehicles and manual vehicles, as the probability of accident can be greater when the ratio between manual to autonomous manual vehicles is larger (e.g., more manual than autonomous).

At block 550, the processor determines from GPS data vehicles types operating in one or more predicted routes. At block 560, the processor, determines a probability that the autonomous vehicle comes within a proximity of the one or more manual vehicles 390 and a duration of such proximity along the preferred route. Proximity can be defined by the system by a geometric distance, such as a radius selected from a range of 1 to 50 meters.

At block 570, the processor, determines a concentration of the autonomous and manual vehicles on the preferred route. The system 300 can predict the concentration of the one or more manual vehicles 390 along with the autonomous vehicles on the preferred route. Further, the system 300 can predict a duration of presence of the autonomous vehicle 320 in autonomous and manual vehicle ecosystem and/or a concentration of one or more manual vehicles 390 in a road where the autonomous vehicle 320 is travelling (e.g., and whether a predicted spacing between all vehicles to limit the accident probability).

At block 580, the processor, based on the mixes and concentration, determines an accident probability. For instance, the system 300 can determine the accident probability based on the predicted ratio between the manual and autonomous vehicles and/or a duration of a presence of the autonomous vehicle in the manual and autonomous vehicle surrounding. At block 590, the processor determines an insurance price based on the accident probability (e.g., the insurance cost/price can be determined based on the chances of accident with manual vehicle).

In accordance with one or more embodiment, a user can be presented with an insurance cost for each of the one or more predicted routes. In this regard, the user can determine or choose a preferred route/path based on the presented insurance costs.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor implemented method comprising:
determining, by a processor, a preferred path from one or more paths for an autonomous vehicle based on a start point and an end point;
dividing, by the processor, the preferred path into one or more segments;
determining, by the processor, one or more risk indexes for each of the one or more segments; and
determining, by the processor, an insurance cost for the preferred path based on the one or more risk indexes.

2. The processor implemented method of claim 1, further comprising:
presenting the insurance cost to a user to receive authorization to insure the autonomous vehicle during travel along the preferred path.

3. The processor implemented method of claim 1, wherein the one or more segments are defined based on road categories or road zones.

4. The processor implemented method of claim 1, wherein each of the one or more risk indexes comprise a value assigned to each of the one or more segments based on one or more factors.

5. The processor implemented method of claim 4, wherein the one or more factors comprise ratios between autonomous and manual vehicles, proximity between the autonomous and manual vehicles, concentration of the autonomous vehicles, or concentration of the autonomous vehicles.

6. The processor implemented method of claim 1, wherein a total risk index is derived from the one or more risk indexes, the total risk index being utilized to determine the insurance cost for the preferred path.

7. The processor implemented method of claim 1, wherein the one or more risk indexes are applied to one or more actuarial tables or spreadsheets identifying a probability that the autonomous vehicle with be involved in an accident while on the preferred path to determine the insurance cost.

8. A computer program product, the computer program product comprising a computer readable storage medium having program instructions embodied therewith, the program instructions executable by a processor to cause:
determining, by the processor, a preferred path from one or more paths for an autonomous vehicle based on a start point and an end point;
dividing, by the processor, the preferred path into one or more segments;
determining, by the processor, one or more risk indexes for each of the one or more segments; and
determining, by the processor, an insurance cost for the preferred path based on the one or more risk indexes.

9. The computer program product of claim 8, wherein the program instructions are further executable by the processor to cause:
presenting the insurance cost to a user to receive authorization to insure the autonomous vehicle during travel along the preferred path.

10. The computer program product of claim 8, wherein the one or more segments are defined based on road categories or road zones.

11. The computer program product of claim 8, wherein each of the one or more risk indexes comprise a value assigned to each of the one or more segments based on one or more factors.

12. The computer program product of claim 11, wherein the one or more factors comprise ratios between autonomous and manual vehicles, proximity between the autonomous and manual vehicles, concentration of the autonomous vehicles, or concentration of the autonomous vehicles.

13. The computer program product of claim 8, wherein a total risk index is derived from the one or more risk indexes, the total risk index being utilized to determine the insurance cost for the preferred path.

14. The computer program product of claim 8, wherein the one or more risk indexes are applied to one or more actuarial tables or spreadsheets identifying a probability that the autonomous vehicle with be involved in an accident while on the preferred path to determine the insurance cost.

15. A system, comprising a processor and a memory storing program instructions thereon, the program instructions executable by a processor to cause:
determining, by the processor, a preferred path from one or more paths for an autonomous vehicle based on a start point and an end point;
dividing, by the processor, the preferred path into one or more segments;
determining, by the processor, one or more risk indexes for each of the one or more segments; and
determining, by the processor, an insurance cost for the preferred path based on the one or more risk indexes.

16. The system of claim 15, the program instructions are further executable by the processor to cause the system to perform:
presenting the insurance cost to a user to receive authorization to insure the autonomous vehicle during travel along the preferred path.

17. The system of claim 15, wherein the one or more segments are defined based on road categories or road zones.

18. The system of claim 15, wherein each of the one or more risk indexes comprise a value assigned to each of the one or more segments based on one or more factors.

19. The system of claim 18, wherein the one or more factors comprise ratios between autonomous and manual vehicles, proximity between the autonomous and manual vehicles, concentration of the autonomous vehicles, or concentration of the autonomous vehicles.

20. The system of claim 15, wherein a total risk index is derived from the one or more risk indexes, the total risk index being utilized to determine the insurance cost for the preferred path.
